(19) United States
(12) Patent Application Publication
(10) Pub. No.: US 2020/0070069 A1
(43) Pub. Date: Mar. 5, 2020

(54) PRESSURE CONTROL DEVICE

(71) Applicant: NIDEC TOSOK CORPORATION, Kanagawa (JP)

(72) Inventors: Takeshi NAKANO, Kanagawa (JP); Yoshinori YAMAKI, Kanagawa (JP); Tomohiro YASUDA, Kanagawa (JP); Weiming CHEN, Kanagawa (JP); Kenta KURAMOCHI, Kanagawa (JP)

(73) Assignee: NIDEC TOSOK CORPORATION, Kanagawa (JP)

(21) Appl. No.: 16/538,809

(22) Filed: Aug. 12, 2019

(30) Foreign Application Priority Data
Aug. 28, 2018 (JP) 2018-158898

(51) Int. Cl. B01D 29/05; B01D 35/30

(52) U.S. Cl. CPC B01D 29/05; F16K 11/07; B01D 35/30

(57) ABSTRACT

A pressure control device capable of preventing a body and a filter unit which are assembled from being disassembled unintentionally is provided. A pressure control device includes: a body, which has a flow path that includes a groove and a widening portion that is connected to the groove and has a width larger than the width of the groove to a bottom portion of the groove; and a filter unit which is accommodated along a depth direction of the widening portion and captures foreign matter mixed in a fluid passing through the flow path. The filter unit has a detachment prevention portion which prevents a detachment form the widening portion.

### CROSS-REFERENCE TO RELATED APPLICATION

This application claims the priority benefit of Japan Application No. 2018-158898, filed on Aug. 28, 2018. The entirety of the above-mentioned patent application is hereby incorporated by reference herein and made a part of this specification.

### BACKGROUND

### Technical Field

The disclosure relates to a pressure control device.

### Related Art

As an oil pressure control device for controlling oil pressure, for example, an oil pressure control device mounted on a motorcar and used in a clutch is known (for example, see patent literature 1). The oil pressure control device described in patent literature 1 includes a body having a flow path through which hydraulic oil passes, and a cylindrical filter which is arranged in the middle of the flow path and captures foreign matter such as powder mixed in the hydraulic oil.

In addition, generally in the oil pressure control device, when the filter is inserted into the flow path of the body and the members are assembled to manufacture an oil pressure control device, the assembly work is usually performed manually, for example.

However, in the oil pressure control device described in patent literature 1, there is a tendency that the narrower the flow path is, that is, the smaller a width of the flow path is, the more difficult it is to perform the work of inserting the filter into this flow path. Therefore, the filter may be in a state of not being properly inserted into the flow path. In this case, for example, the filter may fall off the body if the body and the filter are turned upside down during assembly or excessive vibration is applied during transportation even after assembly.

### LITERATURE OF RELATED ART

### Patent Literature

[Patent literature 1] Japanese Laid-open No. 2014-234829

### SUMMARY

An aspect of the pressure control device of the disclosure includes: a body, which has a flow path including a groove and a widening portion that is connected to the groove and has a width larger than the width of the groove to a bottom portion of the groove; and a filter unit, which is accommodated along a depth direction of the widening portion and captures foreign matter mixed in a fluid passing through the flow path. The filter unit has a detachment prevention portion which prevents a detachment from the widening portion.

### BRIEF DESCRIPTION OF THE DRAWINGS

FIG. 1 is a perspective view showing a pressure control device (a first embodiment) of the disclosure.

FIG. 2 is an exploded perspective view of the pressure control device shown in FIG. 1.

FIG. 3 is a cross-sectional view along an III-III line in FIG. 1.

FIG. 4 is a diagram in which the pressure control device shown in FIG. 1 is viewed from the front side.

FIG. 5 is a longitudinal cross-sectional perspective view showing a part of the pressure control device shown in FIG. 1.

FIG. 6 is a cross-sectional view along a VI-VI line in FIG. 5.

FIG. 7 is an exploded perspective view of the pressure control device shown in FIG. 5.

FIG. 8 is a cross-sectional view along a VIII-VIII line in FIG. 7.

FIG. 9 is a perspective view showing a filter unit included in the pressure control device (a second embodiment) of the disclosure.

FIG. 10 is a cross-sectional view along an X-X line in FIG. 9.

FIG. 11 is a longitudinal cross-sectional view showing a use state of the filter unit shown in FIG. 9.

FIG. 12 is a plan view showing a part of the pressure control device (a third embodiment) of the disclosure.

FIG. 13 is a plan view showing a part of the pressure control device (a fourth embodiment) of the disclosure.

### DESCRIPTION OF THE EMBODIMENTS

The embodiments of the disclosure provide a pressure control device capable of reliably preventing a body and a filter unit which are assembled from being disassembled unintentionally.

According to an aspect of the disclosure, the body and the filter unit which are assembled can be prevented from being disassembled unintentionally.

In the following, a pressure control device of the disclosure is described in detail based on suitable embodiments shown in the accompanying diagrams.

A Z-axis direction in each drawing is set as an up-down direction Z. An X-axis direction is set as a left-right direction X within horizontal directions orthogonal to the up-down direction Z. A Y-axis direction is set as an axial direction Y which is orthogonal to the left-right direction X within the horizontal directions orthogonal to the up-down direction Z. A positive side of the up-down direction Z is referred to as an “upper side”, and a negative side of the up-down direction Z is referred to as a “lower side”. A positive side of the axial direction Y is referred to as a “front side”, and a negative side of the axial direction Y is referred to as a “rear side”. The front side corresponds to one side of the axial direction, and the rear side corresponds to the other side of the axial direction. Besides, the upper side, the lower side, the front side, the rear side, the up-down direction, and the left-right direction are simply named for describing relative position relationships of the respective portions, and actual disposition relationships may be other disposition relationships except the disposition relationships shown by these names. In addition, a “plan view” refers to a state when viewing from the upper side to the lower side.

### First Embodiment

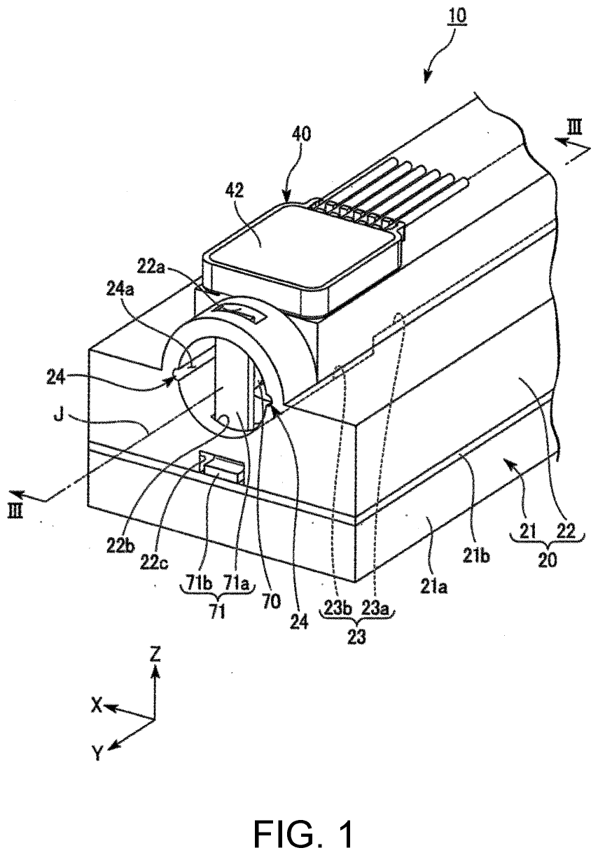

In the following, a first embodiment of the pressure control device of the disclosure is described with reference to FIG. 1-FIG. 8.

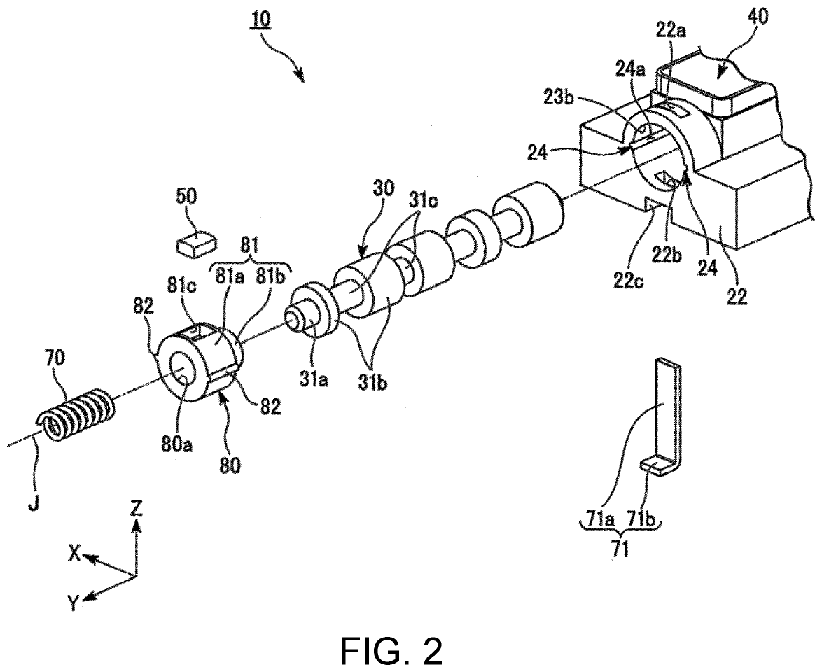

A pressure control device 10 of this embodiment shown in FIG. 1 and FIG. 2 is, for example, a control valve mounted on a vehicle. The pressure control device 10 includes an oil passage body 20, a spool valve 30, a magnet holder 80, a magnet 50, an elastic member 70, a fixed member 71, and a sensor module 40.

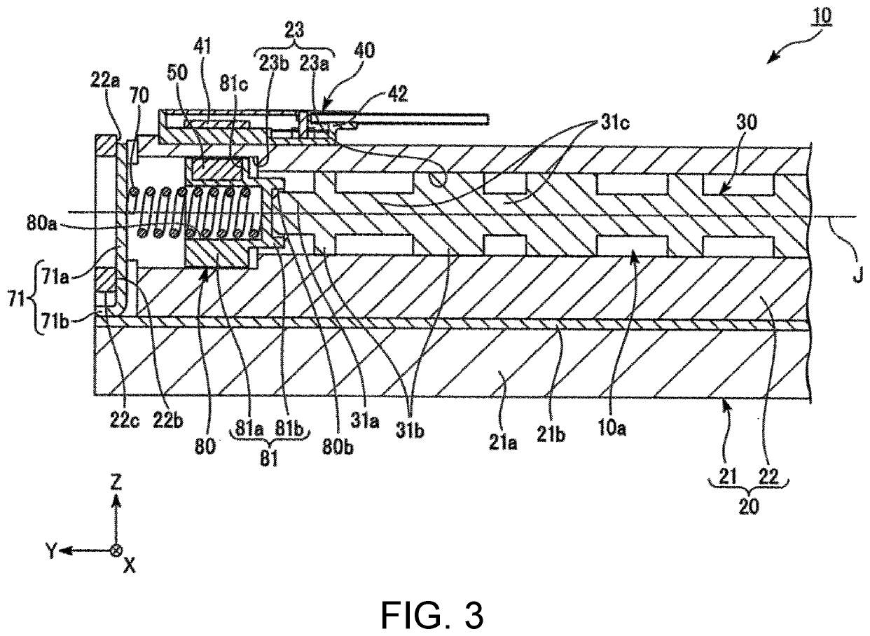

As shown in FIG. 3, the oil passage body 20 has an oil passage 10a inside, in which oil flows. The part of the oil passage 10a indicated in FIG. 3 is a part of the spool hole 23 described later. In each drawing, for example, a state that a part of the oil passage body 20 is cut out is shown. As shown in FIG. 1, the oil passage body 20 has a lower body 21 and an upper body 22. Although illustration is omitted, the oil passage 10a is arranged in both the lower body 21 and the upper body 22 for example.

The lower body 21 has a lower body main part 21a and a separate plate 21b which is disposed overlapping with the upper side of the lower body main part 21a. In the embodiment, an upper surface of the lower body 21 corresponds to an upper surface of the separate plate 21b and is orthogonal to the up-down direction Z. The upper body 22 is disposed overlapping with the upper side of the lower body 21. A lower surface of the upper body 22 is orthogonal to the up-down direction Z. The lower surface of the upper body 22 contacts with the upper surface of the lower body 21, that is, the upper surface of the separate plate 21b.

As shown in FIG. 3, the upper body 22 has a spool hole 23 which extends in the axial direction Y. In the embodiment, the cross-sectional shape of the spool hole 23 orthogonal to the axial direction Y is a circular shape centered on a central axis J. The central axis J extends in the axial direction Y. Besides, the radial direction centered on the central axis J is simply referred to as a “radial direction”, and the peripheral direction centered on the central axis J is simply referred to as a “peripheral direction”.

The spool hole 23 is open at least on the front side. In the embodiment, a rear end of the spool hole 23 is blocked. That is, the spool hole 23 is a hole which is open on the front side and has a bottom portion. Besides, the spool hole 23 may also be, for example, open on both sides of the axial direction Y. At least a part of the spool hole 23 constitutes a part of the oil passage 10a in the oil passage body 20.

The spool hole 23 has a spool hole main part 23a and an introduction hole portion 23b. Although illustration is omitted, the oil passage 10a which is arranged in the part of the oil passage body 20 other than the spool hole 23 is open on an inner peripheral surface of the spool hole main part 23a. An inner diameter of the introduction hole portion 23b is larger than an inner diameter of the spool hole main part 23a. The introduction hole portion 23b is connected to a front end portion of the spool hole main part 23a. The introduction hole portion 23b is a front end portion of the spool hole 23 and is open on the front side.

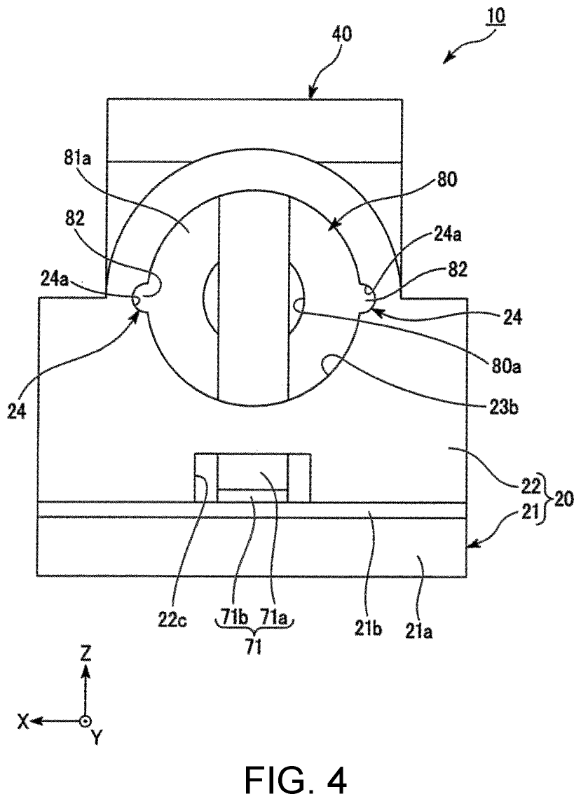

As shown in FIG. 1, the spool hole 23 has groove portions 24 which are hollow radially outward from an inner peripheral surface of the spool hole 23 and extend in the axial direction Y. In the embodiment, a pair of groove portions 24 is arranged with the central axis J in between. The pair of groove portions 24 is hollow from an inner peripheral surface of the introduction hole portion 23b toward both sides of the left-right direction X. The groove portions 24 are arranged from a front end portion on the inner peripheral surface of the introduction hole portion 23b to a rear end portion on the inner peripheral surface of the introduction hole portion 23b. As shown in FIG. 4, inner surfaces 24a of the groove portions 24 have a semicircular arc shape that is concave radially outward from the inner peripheral surface of the introduction hole portion 23b in a view from the front side.

As shown in FIG. 3, the upper body 22 has through holes 22a, 22b, 22c in a front end portion of the upper body 22. The through hole 22a penetrates through a part in the upper body 22 from the upper surface of the upper body 22 to the inner peripheral surface of the introduction hole portion 23b in the up-down direction Z. The through hole 22b penetrates through a part in the upper body 22 from the lower surface of the upper body 22 to the inner peripheral surface of the introduction hole portion 23b in the up-down direction Z. As shown in FIG. 1, the through hole 22a and the through hole 22b have a long rectangular shape in the left-right direction X in a view from the upper side. The through hole 22a and the through hole 22b overlap each other in a view from the upper side.

As shown in FIG. 3, the through hole 22c penetrates through a part in the upper body 22 from the front surface of the upper body 22 to the through hole 22b in the axial direction Y. The through hole 22c is arranged in a lower end portion on the front surface of the upper body 22. The through hole 22c is open on the lower side. As shown in FIG. 4, the through hole 22c has a long rectangular shape in the left-right direction X in a view from the front side. A center in the left-right direction X of the through holes 22a, 22b, 22c is the same as a position of the central axis J in the left-right direction X for example.

As shown in FIG. 1, a part in the upper body 22 in which the spool hole 23 is arranged projects on the upper side of the other part of the upper body 22. The upper surface in the front end portion of this projecting part is a semicircular-arc-shaped curved surface that is convex upward. The through hole 22a is open on an upper end portion of the semicircular-arc-shaped surface. The lower body main part 21a, the separate plate 21b, and the upper body 22 are respectively single members for example. The lower body main part 21a, the separate plate 21b and the upper body 22 are made of non-magnetic material.

As shown in FIG. 3, the spool valve 30 is disposed along the central axis J which extends in the axial direction Y intersecting with the up-down direction Z. The spool valve 30 has a columnar shape. The spool valve 30 is mounted on the oil passage body 20. The spool valve 30 is disposed to be movable in the axial direction in the spool hole 23.

The spool valve 30 moves in the axial direction Y in the spool hole main part 23a, and opens and closes an opening portion of the oil passage 10a which is open on the inner peripheral surface of the spool hole main part 23a. Although illustration is omitted, an oil pressure of oil or a force toward the front side from a driving device such as a solenoid actuator is applied to the rear end portion of the spool valve 30. The spool valve 30 has a support portion 31a, a plurality of large diameter portions 31b, and a plurality of small diameter portions 31c. Each portion of the spool valve 30 has a columnar shape that extends in the axial direction Y about the central axis J.

The support portion 31a is a front end portion of the spool valve 30. A front end portion of the support portion 31a supports a rear end portion of the magnet holder 80. A rear end portion of the support portion 31a is connected to a front end portion of the large diameter portion 31b.

The plurality of large diameter portions 31b and the plurality of small diameter portions 31c are disposed alternately in succession from the large diameter portion 31b connected to the rear end portion of the support portion 31a toward the rear side. An outer diameter of the large diameter portion 31b is larger than an outer diameter of the small diameter portion 31c. In the embodiment, an outer diameter of the support portion 31a is, for example, the same as the outer diameter of the small diameter portion 31c. The outer diameter of the large diameter portion 31b is substantially the same as an inner diameter of the spool hole main part 23a, and is slightly smaller than the inner diameter of the spool hole main part 23a. The large diameter portion 31b can move in the axial direction Y while sliding with respect to the inner peripheral surface of the spool hole main part 23a. The large diameter portion 31b functions as a valve portion which opens and closes the opening portion of the oil passage 10a being open on the inner peripheral surface of the spool hole main part 23a. In the embodiment, the spool valve 30 is, for example, a single member made of metal.

The magnet holder 80 is disposed on the front side of the spool valve 30. The magnet holder 80 is disposed to be movable in the axial direction Y inside the introduction hole portion 23b. The spool valve 30 and the magnet holder 80 are allowed to rotate relatively around the central axis. As shown in FIG. 2, the magnet holder 80 has a holder main part portion 81 and an opposite portion 82.

The holder main part portion 81 is a stepped columnar shape which extends in the axial direction Y about the central axis J. As shown in FIG. 3, the holder main part portion 81 is disposed in the spool hole 23. More specifically, the holder main part portion 81 is disposed in the introduction hole portion 23b. The holder main part portion 81 has a slide portion 81a and a supported portion 81b. That is, the magnet holder 80 has the slide portion 81a and the supported portion 81b.

An outer diameter of the slide portion 81a is larger than the outer diameter of the large diameter portion 31b. The outer diameter of the slide portion 81a is substantially the same as the inner diameter of the introduction hole portion 23b, and is slightly smaller than the inner diameter of the introduction hole portion 23b. The slide portion 81a can move in the axial direction Y while sliding with respect to the inner peripheral surface of the spool hole 23, that is, the inner peripheral surface of the introduction hole portion 23b in the embodiment. A radial outer edge portion of the rear surface of the slide portion 81a can contact with a stepped surface facing the front side in a step which is generated between the spool hole main part 23a and the introduction hole portion 23b. In this way, the magnet holder 80 can be prevented from moving from a contact position of the magnet holder 80 and the stepped surface to the rear side, and the rearmost position of the magnet holder 80 can be determined. As described later, the spool valve 30 receives a backward force from the elastic member 70 via the magnet holder 80, and thus the rearmost position of the spool valve 30 can be determined by determining the rearmost position of the magnet holder 80.

The supported portion 81b is connected to a rear end portion of the slide portion 81a. An outer diameter of the supported portion 81b is smaller than the outer diameter of the slide portion 81a and the outer diameter of the large diameter portion 31b, and is larger than the outer diameter of the support portion 31a and the outer diameter of the small diameter portion 31c. The supported portion 81b is movable in the spool hole main part 23a. The supported portion 81b moves in the axial direction Y between the introduction hole portion 23b and the spool hole main part 23a along with a movement in the axial direction Y of the spool valve 30.

The supported portion 81b has a supported concave portion 80b which is hollow from the rear end portion of the supported portion 81b toward the front side. The support portion 31a is inserted into the supported concave portion 80b. The front end portion of the support portion 31a contacts with the bottom surface of the supported concave portion 80b. In this way, the magnet holder 80 is supported to the spool valve 30 from the rear side. A dimension in the axial direction Y of the supported portion 81b is, for example, smaller than a dimension in the axial direction Y of the slide portion 81a.

As shown in FIG. 2, the opposite portion 82 projects radially outward from the holder main part portion 81. More specifically, the opposite portion 82 projects radially outward from the slide portion 81a. In the embodiment, a pair of opposite portions 82 is arranged with the central axis J in between. The pair of opposite portions 82 projects from an outer peripheral surface of the slide portion 81a toward both sides of the left-right direction X. The opposite portions 82 extend in the axial direction Y from the front end portion of the slide portion 81a to the rear end portion of the slide portion 81a. As shown in FIG. 4, the opposite portions 82 have a semicircular arc shape that is convex radially outward in a view from the front side.

The pair of opposite portions 82 are fitted in the pair of groove portions 24. The opposite portions 82 are opposite in the peripheral direction to the inner surfaces 24a of the groove portions 24 and can be brought into contact with the inner surfaces 24a. Besides, in this specification, “certain two parts are opposite in the peripheral direction” includes that both of the two parts are located in a virtual circle along the peripheral direction and are opposite to each other.

As shown in FIG. 3, the magnet holder 80 has a first concave portion 81c which is hollow radially inward from the outer peripheral surface of the slide portion 81a. In FIG. 3, the first concave portion 81c is hollow downward from the upper end portion of the slide portion 81a. The inner surface of the first concave portion 81c includes a pair of surfaces being opposite in the axial direction Y.

The magnet holder 80 has a second concave portion 80a which is hollow backward from the front end portion in the magnet holder 80. The second concave portion 80a extends from the slide portion 81a to the supported portion 81b. As shown in FIG. 2, the second concave portion 80a has a circular shape centered on the central axis J in a view from the front side. As shown in FIG. 3, the inner diameter of the second concave portion 80a is larger than the inner diameter of the supported concave portion 80b.

The magnet holder 80 may be made of, for example, resin or metal. When the magnet holder 80 is made of resin, the magnet holder 80 can be easily manufactured. In addition, manufacturing cost of the magnet holder 80 can be reduced. When the magnet holder 80 is made of metal, dimensional accuracy of the magnet holder 80 can be improved.

As shown in FIG. 2, the magnet 50 has a substantially rectangular parallelepiped shape. The upper surface of the magnet 50 is, for example, a surface which is curved into a circular arc shape along the peripheral direction. As shown in FIG. 3, the magnet 50 is accommodated in the first concave portion 81c and is fixed to the holder main part portion 81. In this way, the magnet 50 is fixed to the magnet holder 80. The magnet 50 is fixed by an adhesive for example. The radial outer surface of the magnet 50 is, for example, located closer to the radial inside than the outer peripheral surface of the slide portion 81a. The radial outer surface of the magnet 50 is opposite to the inner peripheral surface of the introduction hole portion 23b via a gap in the radial direction.

As described above, the slide portion 81a on which the first concave portion 81c is arranged moves while sliding with respect to the inner peripheral surface of the spool hole 23. Therefore, the outer peripheral surface of the slide portion 81a is in contact with the inner peripheral surface of the spool hole 23 or opposite to the inner peripheral surface of the spool hole 23 via a narrow gap. Thus, it is hard for foreign matter such as metal pieces contained in oil to enter the first concave portion 81c. Accordingly, the foreign matter such as metal pieces contained in oil can be prevented from being attached to the magnet 50 accommodated in the first concave portion 81c. When the magnet holder 80 is made of metal, dimensional accuracy of the slide portion 81a can be improved, and thus it is even harder for the foreign matter such as metal pieces contained in oil to enter the first concave portion 81c.

As shown in FIG. 2, the fixed member 71 has a plate shape in which a plate surface is parallel to the left-right direction X. The fixed member 71 has an extension portion 71a and a bend portion 71b. The extension portion 71a extends in the up-down direction Z. The extension portion 71a has a long rectangular shape in the up-down direction Z in a view from the front side. As shown in FIG. 1 and FIG. 3, the extension portion 71a is inserted into the introduction hole portion 23b via the through hole 22b. The upper end portion of the extension portion 71a is inserted into the through hole 22a. The extension portion 71a blocks a part of the front opening of the introduction hole portion 23b. The bend portion 71b bends forward from the lower end portion of the extension portion 71a. The bend portion 71b is inserted into the through hole 22c. The fixed member 71 is disposed on the front side of the elastic member 70.

In the embodiment, before the upper body 22 and the lower body 21 overlap each other, the fixed member 71 is inserted from the opening portion of the through hole 22b which is open on the lower surface of the upper body 22 to the through hole 22a via the through hole 22b and the introduction hole portion 23b. Then, as shown in FIG. 1, the upper body 22 and the lower body 21 are laminated and combined in the up-down direction Z, and thereby the bend portion 71b inserted into the through hole 22c is supported from the lower side by the upper surface of the lower body 21. In this way, the fixed member 71 can be mounted with respect to the oil passage body 20.

As shown in FIG. 3, the elastic member 70 is a coil spring which extends in the axial direction Y. The elastic member 70 is disposed on the front side of the magnet holder 80. In the embodiment, at least a part of the elastic member 70 is disposed in the second concave portion 80a. Therefore, at least a part of the elastic member 70 can be made to overlap the magnet holder 80 in the radial direction, and dimension in the axial direction Y of the pressure control device 10 is miniaturized easily. In the embodiment, the rear side part of the elastic member 70 is disposed in the second concave portion 80a.

The rear end portion of the elastic member 70 contacts with the bottom surface of the second concave portion 80a. The front end portion of the elastic member 70 contacts with the fixed member 71. In this way, the front end portion of the elastic member 70 is supported by the fixed member 71. The fixed member 71 receives a forward elastic force from the elastic member 70, and the extension portion 71a is pressed to the front inner surfaces of the through holes 22a, 22b.

By supporting the front end portion of the elastic member 70 by the fixed member 71, the elastic member 70 applies a backward elastic force to the spool valve 30 via the magnet holder 80. Therefore, for example, at a position in which an oil pressure of oil or a force applied from a driving device such as a solenoid actuator which is applied to the rear end portion of the spool valve 30 counterbalances the elastic force of the elastic member 70, the position in the axial direction Y of the spool valve 30 can be maintained. In this way, by changing the force applied to the rear end portion of the spool valve 30, the position in the axial direction Y of the spool valve 30 can be changed, and opening and closing of the oil passage 10a in the oil passage body 20 can be switched.

In addition, by the oil pressure of oil or the force applied from a driving device such as a solenoid actuator which is applied to the rear end portion of the spool valve 30 and the elastic force of the elastic member 70, the magnet holder 80 and the spool valve 30 can be pressed to each other in the axial direction Y. Therefore, the magnet holder 80 moves in the axial direction Y along with the movement in the axial direction Y of the spool valve 30 while a relative rotation around the central axis with respect to the spool valve 30 is allowed.

The sensor module 40 has a housing 42 and a magnetic sensor 41. The housing 42 accommodates the magnetic sensor 41. As shown in FIG. 1, the housing 42 has, for example, a flat rectangular parallelepiped box shape in the up-down direction Z. The housing 42 is fixed to a flat surface which is located on the rear side of the semicircular-arc-shaped curved surface on which the through hole 22a is arranged within the upper surface of the upper body 22.

As shown in FIG. 3, the magnetic sensor 41 is fixed to the bottom surface of the housing 42 in the housing 42. In this way, the magnetic sensor 41 is mounted on the oil passage body 20 via the housing 42. The magnetic sensor 41 detects a magnetic field of the magnet 50. The magnetic sensor 41 is a Hall element for example. Besides, the magnetic sensor 41 may also be a magneto resistance element.

When the position in the axial direction Y of the magnet 50 is changed along with the movement in the axial direction Y of the spool valve 30, the magnetic field of the magnet 50 passing through the magnetic sensor 41 is changed. Therefore, by detecting the change of the magnetic field of the magnet 50 by the magnetic sensor 41, the position in the axial direction Y of the magnet 50, that is, the position in the axial direction Y of the magnet holder 80 can be detected. As described above, the magnet holder 80 moves in the axial direction Y along with the movement in the axial direction Y of the spool valve 30. Therefore, by detecting the position in the axial direction Y of the magnet holder 80, the position in the axial direction Y of the spool valve 30 can be detected.

The magnetic sensor 41 overlaps the magnet 50 in the up-down direction Z. That is, as least a part of the magnet 50 overlaps the magnetic sensor 41 in a direction parallel to the up-down direction Z within the radial directions. Therefore, the magnetic field of the magnet 50 is easily detected by the magnetic sensor 41. Accordingly, by the sensor module 40, a displacement in the axial direction Y of the magnet holder 80, that is, a displacement in the axial direction Y of the spool valve 30 can be detected more accurately.

Besides, in this specification, “at least a part of the magnet overlaps the magnetic sensor in the radial direction” means that at least a part of the magnet may overlap the magnetic sensor in the radial direction in at least some positions within a range in which the spool valve to which the magnet is directly fixed moves in the axial direction. That is, for example, when the spool valve 30 and the magnet holder 80 displace in the axial direction Y from the position in FIG. 3, the magnet 50 may not overlap the magnetic sensor 41 in the up-down direction Z. In the embodiment, as long as the magnet 50 is in a range in which the spool valve 30 moves in the axial direction Y, the magnet 50 partially overlaps the magnetic sensor 41 in the up-down direction Z at any position.

The pressure control device 10 further includes a rotation stop portion. The rotation stop portion is a part capable of contacting with the magnet holder 80. In the embodiment, the rotation stop portion is the inner surfaces 24a of the groove portions 24. That is, the opposite portions 82 are opposite in the peripheral direction to the inner surfaces 24a serving as rotation stop portions and can contact with the inner surfaces 24a.

Therefore, according to the embodiment, for example, when the opposite portions 82 are about to rotate around the central axis J, the opposite portions 82 contact with the inner surfaces 24a serving as rotation stop portions. In this way, rotation of the opposite portions 82 is suppressed by the inner surfaces 24a, and the magnet holder 80 is suppressed from rotating around the central axis J. Accordingly, the magnet 50 fixed to the magnet holder 80 can be suppressed from being misaligned in the peripheral direction. Therefore, when the position in the axial direction Y of the spool valve 30 is not changed, position information in the axial direction Y of the magnet 50 detected by the magnetic sensor 41 can be suppressed from being changed even if the spool valve 30 rotates around the central axis J. In this way, position information of the spool valve 30 can be suppressed from being changed, and an accuracy of grasping the position in the axial direction Y of the spool valve 30 can be improved.

In addition, according to the embodiment, the rotation stop portion is the inner surfaces 24a of the groove portions 24. Therefore, it is possible not to prepare another member as a rotation stop portion, and the number of components of the pressure control device 10 can be reduced. In this way, time and labor required for the assembly of the pressure control device 10 and manufacturing cost of the pressure control device 10 can be reduced.

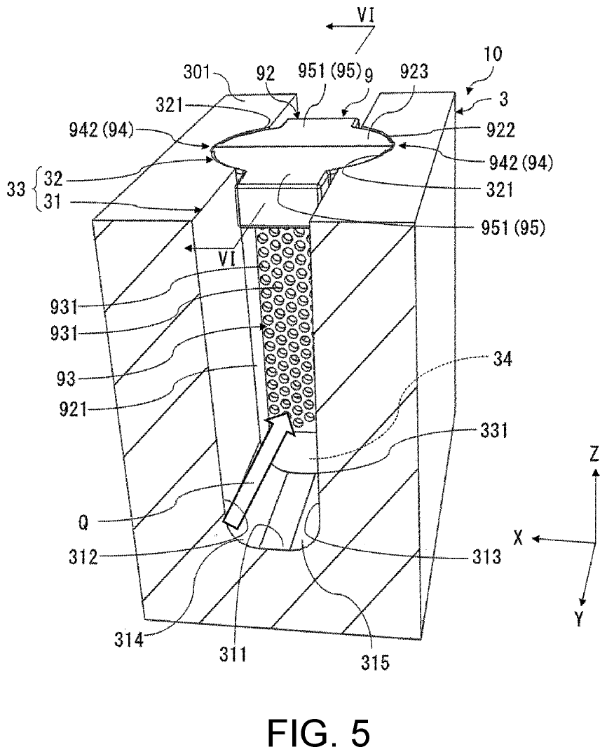

As described above, there is a case that oil passing through the pressure control device 10 contains foreign matter such as metal pieces and the like. Such foreign matter may be captured in a process that oil passes through the pressure control device 10, and may be prevented from further flowing to the downstream side. Thus, the pressure control device 10 is configured to be capable of capturing foreign matter. In the following, this configuration and action are described with reference to FIG. 5-FIG. 8.

Besides, in the embodiment, the pressure control device 10 is applied in, but not limited to, the oil pressure control device for controlling oil pressure. A device to which the pressure control device 10 is applicable includes, in addition to the oil pressure control device, for example, a water pressure control device for controlling water pressure, an air pressure control device for controlling air pressure and the like. In this case, the substance passing through the pressure control device 10 is a fluid such as oil, water, air and the like, and the following description is given with these fluids being collectively referred to as a “fluid Q”.

As shown in FIG. 5, the pressure control device 10 further includes a filter unit 9 mounted on the body 3 in addition to the above-described spool valve 30, the magnet holder 80, the magnet 50, the elastic member 70, the fixed member 71, the sensor module 40 and the like.

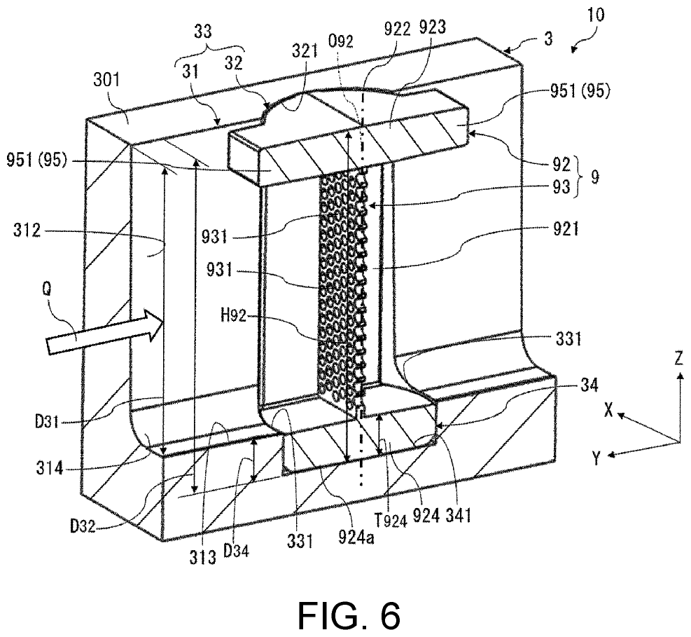

The body 3 can be at least one of the lower body 21 and the upper body 22 constituting the oil passage body 20. As shown in FIG. 5 and FIG. 6, the body 3 has a flow path 33 which is arranged in a hollow shape on an upper surface (surface) 301, and through which the fluid Q passes. The flow path 33 includes a groove 31 and a widening portion 32 connected to the groove 31, and constitutes a part of the oil passage 10a.

The groove 31 has a bottom portion (a first bottom portion) 311, a side wall portion 312 located on the left side of the bottom portion 311, and a side wall portion 313 located on the right side of the bottom portion 311. Besides, a boundary portion 314 between the bottom portion 311 and the side wall portion 312 and a boundary portion 315 between the bottom portion 311 and the side wall portion 313 may be rounded as shown in FIG. 5. In this way, the fluid Q can smoothly pass through the vicinity of the boundary portion 314 and the boundary portion 315.

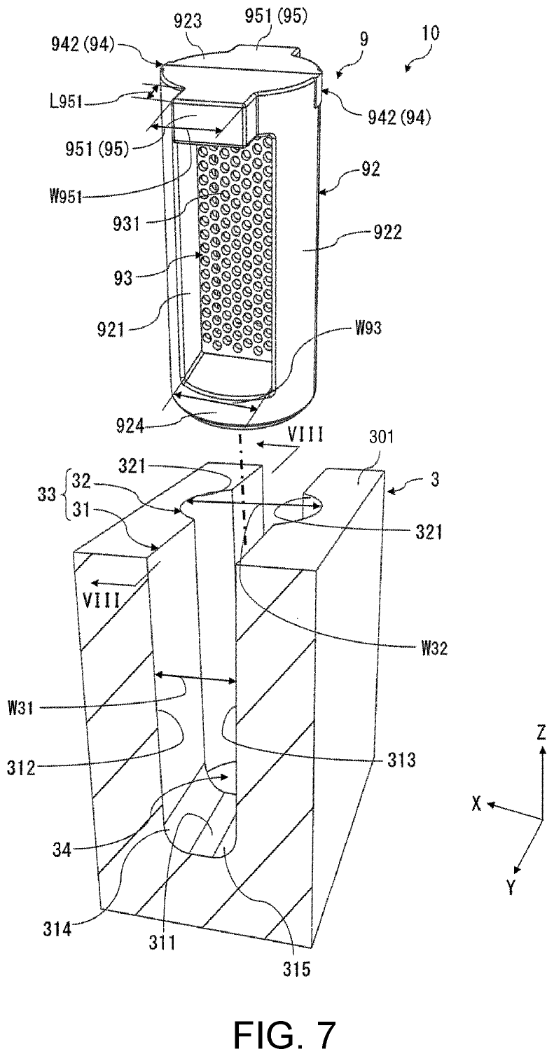

The groove 31 has, but not limited to, a linear shape along the axial direction Y in a plan view of the body 3, and may has a part that at least partially bends. A width (a first width) W₃₁ (see FIG. 7) of the groove 31 which is a space between the side wall portion 312 and the side wall portion 313 is substantially constant along the axial direction Y. In addition, a depth (a first depth) D₃₁ of the groove 31 which is a depth from the surface 301 to the bottom portion 311 is also substantially constant along the axial direction Y.

The widening portion 32 is arranged in a longitudinal direction of the groove 31, that is, in the middle of the axial direction Y. The width of the widening portion 32 is larger than the width W₃₁ of the groove 31 from the surface 301 to the bottom portion 311, and the widening portion 32 functions as an accommodation portion in which the cylindrical filter unit 9 is accommodated. The width W₃₂ (see FIG. 7) of the widening portion 32 gradually increases from the upstream side toward the downstream side, that is, from the front side toward the rear side, and gradually decreases from the middle toward the downstream side. Particularly, in the embodiment, the widening portion 32 has a curved portion 321 which is curved into a circular arc shape in a plan view.

The widening portion 32 having such a shape can be processed using an end mill for example.

As shown in FIG. 6, the widening portion 32 maintains a constant width W₃₂ along the up-down direction Z, and a depth (a second depth) D₃₂ from the surface 301 to a bottom surface (a second bottom portion) 341 is larger than the depth D₃₁ of the groove 31. The widening portion 32 has a reception portion 34 in the bottom portion, where a lower part of the filter unit 9 enters. Obviously, a depth D₃₄ of the reception portion 34 is equivalent to a difference between the depth D₃₂ and the depth D₃₁.

As shown in FIG. 5 and FIG. 6, the filter unit 9 is accommodated along a direction of the depth D₃₂ of the widening portion 32 (that is, the up-down direction Z). The filter unit 9 can capture the foreign matter mixed in the fluid Q when the fluid Q passes through the flow path 33. In this way, for example, an operation failure of the pressure control device 10 caused by foreign matter can be prevented or suppressed. This failure includes, for example, a movement inhibition when the spool valve 30 moves in the spool hole 23, and the like.

The filter unit 9 has a cylindrical frame body 92 and a flat-plate-shaped filter member 93 disposed on the inside of the frame body 92.

The filter member 93 is disposed along a central axis O₉₂ of the frame body 92, and a thickness direction of the filter member 93 is parallel to the axial direction Y. In this way, the filter member 93 can face the fluid Q passing through the flow path 33.

The filter member 93 has multiple small pores 931 which penetrate in the thickness direction of the filter member 93. These small pores 931 are spaced and disposed along both the left-right direction X and the up-down direction Z. In addition, the size of each small pore 931 is substantially a size to a degree of preventing the passing of the foreign matter and not obstructing the flow of the fluid Q. The specific size of each small pore 931 may be 0.1-0.5 mm, or 0.3-0.4 mm, in diameter. In addition, the total area of the small pores 931 may be 10-20 mm², or 12-13 mm². By such small pores 931, the capability of the filter unit 9 to capture foreign matter is improved.

In addition, the filter member 93 is supported on the inside of the frame body 92. In this way, when the fluid Q passes through the filter member 93, the filter member 93 is prevented from deforming due to the flow of the fluid Q, and thus foreign matter can be reliably captured by the filter member 93. As a result, the capability of the filter unit 9 to capture foreign matter is further improved.

As shown in FIG. 7, a width W₉₃ of the filter member 93 is the same as the width of the groove 31 located on the upstream side of the widening portion 32. In this way, when the fluid Q passes through the filter member 93, the capture area of the filter member 93 for capturing foreign matter can be ensured as much as possible, and thus the capability of the filter unit 9 to capture foreign matter is further improved. Besides, in this embodiment, the width W₉₃ is, but not limited to be, the same as the width W₃₁; for example, the width W₉₃ may be larger than the width W₃₁.

As shown in FIG. 6, the frame body 92 has a cylindrical shape, and includes a through hole portion 921 which penetrates in parallel to the axial direction Y orthogonal to the central axis O₉₂ of the frame body 92. Besides, in this embodiment, the appearance shape of the frame body 92 is, but not limited to, a cylindrical shape; for example, the appearance shape of the frame body 92 may be a square cylinder shape.

Then, the filter member 93 covers the through hole portion 921 to be disposed along the central axis of the frame body 92. In this way, the filter member 93 and the frame body 92 are unitized and configured as one component, that is, the filter unit 9.

When the body 3 and the filter unit 9 are assembled, the assembly can be performed by simple work of inserting the filter unit 9 into the widening portion 32. In addition, as described above, the widening portion 32 is wider than the groove 31. In this way, the insertion of the filter unit 9 into the widening portion 32 can be performed easily regardless of the width W₃₁ of the groove 31, and thus workability during the assembly of the body 3 and the filter unit 9 is improved.

As shown in FIG. 7, the frame body 92 has a cylindrical shape as described above, and thus the outer periphery portion 922 of the frame body 92 is rounded into a circular arc shape. On the other hand, in the widening portion 32 in which the filter unit 9 is accommodated, the curved shape of the curved portion 321 is curved along a circular-arc-shaped roundness of the outer periphery portion 922 of the frame body 92. In this way, when the body 3 and the filter unit 9 are assembled, the filter unit 9 can be easily inserted into the widening portion 32.

As shown in FIG. 5 and FIG. 6, the frame body 92 (the filter unit 9) has a height H₉₂ to the degree of not projecting upward from the flow path 33 in a state of being accommodated in the widening portion 32. Besides, the height H₉₂ is equivalent to the depth D₃₂. In this way, when another member is put on the upper side and assembled to the body 3 and the filter unit 9 being in an assembled state, this member is easily assembled as the frame body 92 does not project from the flow path 33.

In addition, the cylindrical frame body 92 has a blocking wall portion 923 which blocks the upper side in the central axis O₉₂, and a blocking wall portion 924 which blocks the lower side. In a state that the filter unit 9 is accommodated in the widening portion 32, a lower portion (a part) of the filter unit 9, that is, the blocking wall portion 924 within the blocking wall portion 923 and the blocking wall portion 924 can enter the reception portion 34.

For such a configuration, for example, when the reception portion 34 is omitted from the widening portion 32, the bottom portion of the widening portion 32 and the bottom portion 311 of the groove 31 have the same height and are in succession. Then, it is likely that a small gap is generated between the bottom portion of the widening portion 32 and an end surface 924a of the blocking wall portion 924 when the filter unit 9 is accommodated in the widening portion 32. A flow passing through the gap may be generated in the fluid Q; in this case, the foreign matter flows to the downstream side across the filter unit 9 instead of being captured by the filter unit 9.

As described above, the pressure control device 10 is configured in a manner that the blocking wall portion 924 of the filter unit 9 enters the reception portion 34 of the widening portion 32. In other words, in the pressure control device 10, a step 331 is generated in a space (a boundary) between the bottom portion 311 of the groove 31 and the bottom surface 341 of the reception portion 34, and the blocking wall portion 924 is disposed to eliminate the step 331. In this way, it is substantially difficult to generate a flow of the fluid Q flowing around the space between the blocking wall portion 924 and the reception portion 34, and thus the foreign matter can be prevented from flowing to the downstream side across the filter unit 9. In addition, even if a gap is generated between the blocking wall portion 924 and the reception portion 34, the size of this gap can be suppressed to 0.4 mm or less.

A thickness T₉₂₄ of the blocking wall portion 924 is the same as the depth D₃₄ of the reception portion 34. For example, a step is generated between the bottom portion 311 of the groove 31 and the blocking wall portion 924 when the thickness T₉₂₄ and the depth D₃₄ are different, and it is likely that the smooth passing of the fluid Q through the filter unit 9 is obstructed due to the size of this step. In the pressure control device 10, the thickness T₉₂₄ and the depth D₃₄ are the same and thereby the step can be eliminated, and thus the fluid Q can smoothly pass through the filter unit 9. In addition, because the fluid Q can pass smoothly, it is more difficult to generate a flow of the fluid Q flowing around the space between the blocking wall portion 924 and the reception portion 34. In this way, the foreign matter can be more reliably prevented from flowing to the downstream side across the filter unit 9.

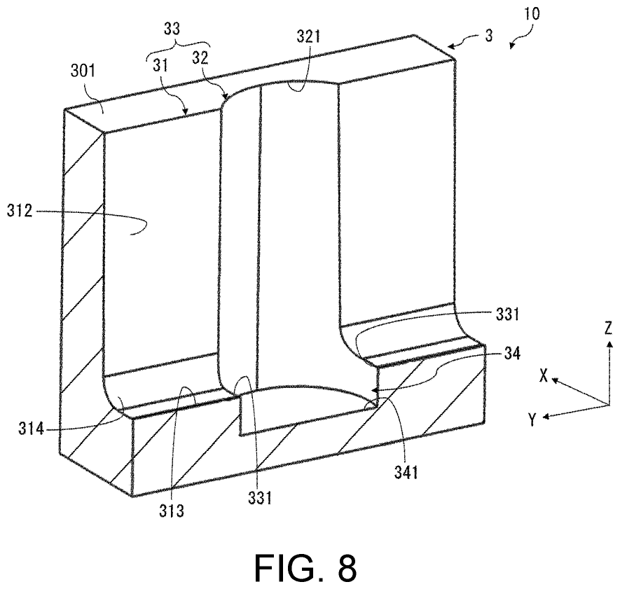

As shown in FIG. 8, the reception portion 34 has a flat bottom surface 341. Then, as shown in FIG. 6, in a state that the filter unit 9 is accommodated in the widening portion 32, the entire end surface 924a of the blocking wall portion 924 of the filter unit 9 can contact with the bottom surface 341. In this way, a gesture of the filter unit 9 in the widening portion 32 is stable even in a state that the fluid Q passes through the flow path 33, and thus the foreign matter can be captured stably.

As shown in FIG. 5 and FIG. 6, the filter unit 9 has a defining portion 95 which defines a disposition direction with respect to the groove 31 in a state of being accommodated in the widening portion 32 and stops rotation of the filter unit 9 around the central axis O₉₂. The defining portion 95 is configured by a pair of projection portions 951 which are arranged projecting in a block shape or a plate shape on the blocking wall portion 923 of the frame body 92. One projection portion 951 of the projection portions 951 projects toward the groove 31 located on the upstream side of the widening portion 32, that is, toward the front side of the axial direction Y, and the other projection portion 951 projects toward the groove 31 located on the downstream side of the widening portion 32, that is, toward the rear side of the axial direction Y.

Besides, the defining portion 95 may not have a pair of projection portions 951; for example, one projection portion 951 may be omitted.

In addition, a width W₉₅₁ of each projection portion 951 may be a little smaller than the width W₃₁ of the groove 31.

Then, each projection portion 951 is disposed in the groove 31 in a state that the filter unit 9 is accommodated in the widening portion 32. In addition, at this time, each projection portion 951 may also be in contact with at least one of the side wall portion 312 and the side wall portion 313 of the groove 31. By such projection portions 951, the disposition direction with respect to the groove 31 is properly defined in a state that the filter unit 9 is accommodated in the widening portion 32, and thus the rotation around the central axis O₉₂ is prevented. In this way, regardless of the flow of the fluid Q, the filter member 93 can be opposite to the flow direction of the fluid Q, and thus the foreign matter can be captured stably.

In addition, the defining portion 95 can be configured by the projection portion 951 having a simple shape and thus contributes to high efficiency during the manufacturing of the filter unit 9.

In addition, by arranging the defining portion 95 in the blocking wall portion 923 of the frame body 92, the defining portion 95 can be disposed toward the corner of the flow path 33 as much as possible, and thus the defining portion 95 can be prevented or suppressed from obstructing the flow of the fluid Q.

As shown in FIG. 5, the filter unit 9 has a detachment prevention portion 94 which prevents a detachment from the widening portion 32 after being inserted into the widening portion 32. The detachment prevention portion 94 is configured by a pair of flattened projection portions 942 which has a flattened shape and which are arranged projecting on the blocking wall portion 923 of the frame body 92. As shown in FIG. 7, one flattened projection portion 942 of the flattened projection portions 942 projects on the left side of the left-right direction X, and the other flattened projection portion 942 projects on the right side of the left-right direction X. Then, in a state that the filter unit 9 is accommodated in the widening portion 32, each flattened projection portion 942 is pressed to the widening portion 32 toward the projection direction of this flattened projection portion 942. In this way, the detachment of the filter unit 9 from the widening portion 32 can be prevented. In the following, an effect of the detachment prevention portion 94 may be referred to as a “detachment prevention effect”. Due to the detachment prevention effect, for example, even if the body 3 and the filter unit 9 in an assembled state are turned upside down, or vibration is applied during transportation, the situation that the filter unit 9 is detached from the widening portion 32 and the body 3 and the filter unit 9 are disassembled unintentionally can be prevented.

In the filter unit 9 with the above configuration, for example, the frame body 92 may be made of resin, and the filter member 93 may be made of metal. In this way, the filter unit 9 can be used as an insert molded article of the frame body 92 and the filter member 93. In this way, high efficiency during the manufacturing of the filter unit 9 can be achieved. Particularly, the frame body 92 has a cylindrical shape and thereby the filter unit 9 is formed easily.

### Second Embodiment

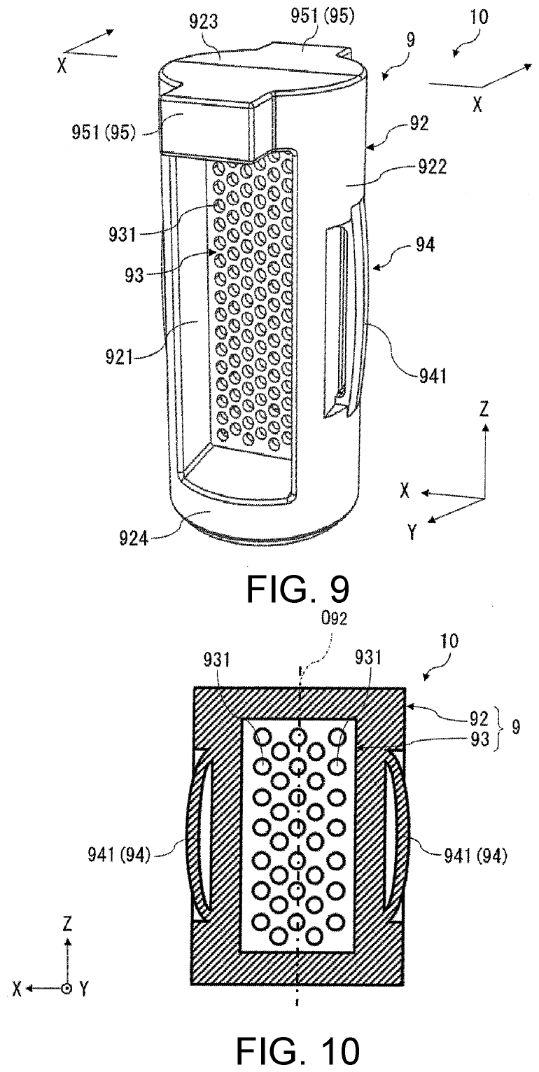

In the following, a second embodiment of the pressure control device of the disclosure is described with reference to FIG. 9-FIG. 11, but the description is made centering on differences with the above-described embodiment, and description of the same matters are omitted.

This embodiment is similar to the first embodiment except that the configuration of the detachment prevention portion is different.

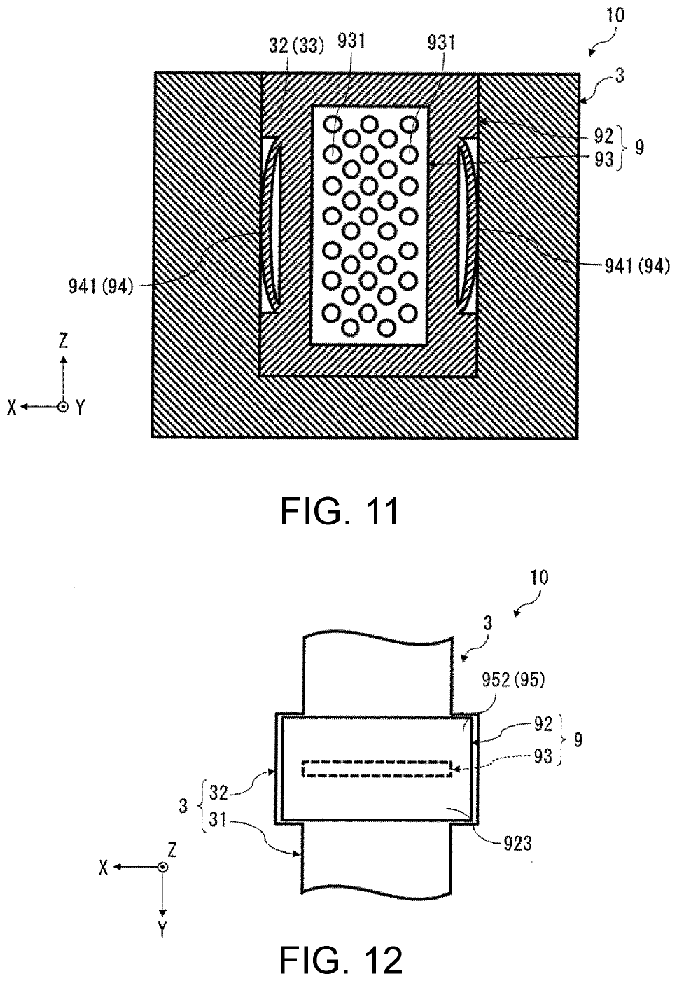

As shown in FIG. 9 and FIG. 10, in this embodiment, the detachment prevention portion 94 has a pair of elastic sheets 941 which is arranged on the outer periphery portion 922 of the frame body 92 and which deforms elastically. As shown in FIG. 11, each elastic sheet 941 can be pressed to the widening portion 32 and deform elastically in a state that the filter unit 9 is accommodated in the widening portion 32. In this way, the filter unit 9 is prevented from being detached from the widening portion 32, and thus the body 3 and the filter unit 9 can be prevented from being disassembled unintentionally.

Each elastic sheet 941 is disposed parallel to the up-down direction Z and is supported at both ends. In addition, each elastic sheet 941 arches in a natural state that no external force is applied, that is, in a state that the filter unit 9 is not yet accommodated in the widening portion 32. In this way, each elastic sheet 941 deforms easily when an external force is applied. In addition, each elastic sheet 941 closely adheres to the widening portion 32 after deforming and can prevent the filter unit 9 from being detached from the flow path 33.

In addition, each elastic sheet 941 is disposed parallel to the up-down direction Z in the outer periphery portion 922 of the frame body 92 and arches, and thereby when an operation of inserting the filter unit 9 toward the lower side of the up-down direction Z into the widening portion 32 is performed, this elastic sheet 941 can be prevented from obstructing the operation.

As shown in FIG. 10, the pair of elastic sheets 941 are disposed oppositely via the central axis O₉₂ of the frame body 92; one elastic sheet 941 is located on the left side of the left-right direction X, and the other elastic sheet 941 is located on the right side of the left-right direction X. In this way, the detachment prevention effect of the detachment prevention portion 94 is exerted stably.

### Third Embodiment

In the following, a third embodiment of the pressure control device of the disclosure is described with reference to FIG. 12, but the description is made centering on differences with the above-described embodiments, and description of the same matters are omitted.

This embodiment is similar to the first embodiment except that the configuration of the defining portion is different.

As shown in FIG. 12, in this embodiment, the defining portion 95 is configured by a non-circular portion 952 having a non-circular shape in which the blocking wall portion 923 of the frame body 92 has a rectangular shape in a plan view. In regard to the non-circular portion 952, a long side direction is parallel to the left-right direction X and a short side direction is parallel to the axial direction Y. Besides, the blocking wall portion 924 of the frame body 92 may also have the same shape as the blocking wall portion 923.

By such a non-circular portion 952, the filter unit 9 is prevented from rotating around the central axis O₉₂ in a state of being accommodated in the widening portion 32, and thus the foreign matter can be stably and reliably captured by the filter member 93.

In addition, the defining portion 95 can be configured by the projection portion 952 having a simple shape and thus contributes to high efficiency during the manufacturing of the filter unit 9.

### Fourth Embodiment

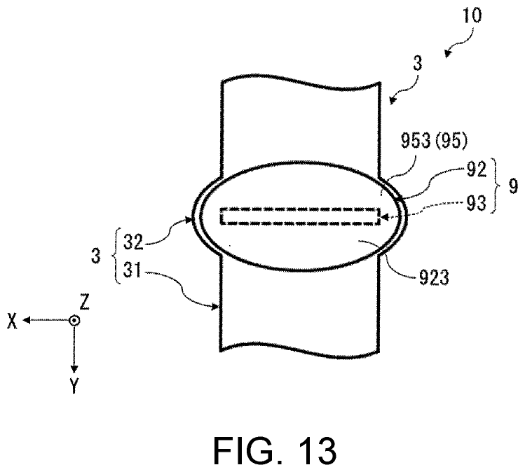

In the following, a fourth embodiment of the pressure control device of the disclosure is described with reference to FIG. 13, but the description is made centering on differences with the above-described embodiments, and description of the same matters are omitted.

This embodiment is similar to the first embodiment except that the shape of the defining portion is different.

As shown in FIG. 13 in this embodiment, the defining portion 95 is configured by a non-circular portion 953 having a non-circular shape in which the blocking wall portion 923 of the frame body 92 has an elliptic shape in a plan view. In regard to the non-circular portion 953, a long diameter direction is parallel to the left-right direction X and a narrow diameter direction is parallel to the axial direction Y. Besides, the blocking wall portion 924 of the frame body 92 may also have the same shape as the blocking wall portion 923.

By such a non-circular portion 953, the filter unit 9 is prevented from rotating around the central axis O₉₂ in a state of being accommodated in the widening portion 32, and thus the foreign matter can be stably and reliably captured by the filter member 93.

In addition, the defining portion 95 can be configured by the projection portion 953 having a simple shape and thus contributes to high efficiency during the manufacturing of the filter unit 9.

In addition, since the non-circular portion 953 has a rounded shape in a plan view, compared with the non-circular portion 952 having a square shape for example, when the work of inserting the filter unit 9 into the widening portion 32 is performed, the non-circular portion 953 contributes to easy and quick completion of this work.

The illustrated embodiments of the pressure control device of the disclosure are described above, but the disclosure is not limited hereto, and each portion constituting the pressure control device can be replaced with a portion having any configuration that can perform similar functions. In addition, any composition may be added.

In addition, the pressure control device of the disclosure may combine optional two or more configurations (features) in the above-described embodiments.

In addition, the filter member is disposed along the central axis of the frame body in the above-described embodiments, but the disclosure is not limited hereto. For example, the filter member may be disposed to be curved into an arch shape, or be disposed to bend into a doglegged shape. In addition, the flat-plate-shaped filter member may be disposed at an angle to the central axis of the frame body.

What is claimed is:

1. A pressure control device, comprising: a body, which has a flow path comprising a groove and a widening portion that is connected to the groove and has a width larger than the width of the groove to a bottom portion of the groove; and
a filter unit, which is accommodated along a depth direction of the widening portion and captures foreign matter mixed in a fluid passing through the flow path;
wherein the filter unit has a detachment prevention portion which prevents a detachment from the widening portion.

2. The pressure control device according to claim 1, wherein the detachment prevention portion has an elastic sheet which is pressed to the body and deforms elastically in a state that the filter unit is accommodated in the widening portion.

3. The pressure control device according to claim 2, wherein the elastic sheet is supported at both ends, and arches in a natural state that no external force is applied.

4. The pressure control device according to claim 2, wherein the filter unit has a tubular frame body which comprises a through hole portion penetrating in a direction orthogonal to a central axis of the frame body, and a flat-plate-shaped filter member which covers the through hole portion and is disposed along the central axis of the frame body; and
the frame body has the elastic sheet.

5. The pressure control device according to claim 2, wherein the elastic sheet is oppositely disposed in pair via the central axis of the frame body.

6. The pressure control device according to claim 1, wherein the filter unit has a defining portion which defines a disposition direction with respect to the groove.

7. The pressure control device according to claim 6, wherein the defining portion has a projection portion which projects toward the groove located on an upstream side or a downstream side of the widening portion.

8. The pressure control device according to claim 7, wherein the filter unit has a tubular frame body which comprises a through hole portion penetrating in the direction orthogonal to a central axis of the frame body, and a flat-plate-shaped filter member which covers the through hole portion and is disposed along the central axis of the frame body; and
the frame body has the projection portion.

9. The pressure control device according to claim 8, wherein the frame body has blocking wall portions which respectively blocks two sides in a direction of the central axis of the frame body; and
one blocking wall portion of the blocking wall portions has the projection portion.

10. The pressure control device according to claim 6, wherein the defining portion is configured by a non-circular part.
